(19) United States
(12) Patent Application Publication
(10) Pub. No.: US 2025/0238310 A1
(43) Pub. Date: Jul. 24, 2025

(54) MACHINE-LEARNING BASED SYSTEM LOG ANOMALY DETECTION AND REMEDIATION

(71) Applicant: Dell Products L.P., Round Rock, TX (US)

(72) Inventors: Ramakanth Kanagovi, Hyderabad (IN); Saheli Saha, Kolkata (IN); Guhesh Swaminathan, Chennai (IN)

(21) Appl. No.: 18/418,581

(22) Filed: Jan. 22, 2024

(51) Int. Cl. G06F 11/07

(52) U.S. Cl. CPC G06F 11/0793; G06F 11/0727; G06F 11/079

(57) ABSTRACT

An apparatus comprises at least one processing device configured to generate a first data structure comprising a numerical representation of content of a given system log associated with an information technology asset, to utilize the first data structure to determine a system log cluster to which the given system log belongs, to select non-anomalous system logs which are part of the system log cluster, and to perform contextual contrastive tuning of a machine learning model utilizing the selected non-anomalous system logs. The at least one processing device is further configured to generate a second data structure utilizing the tuned machine learning model which takes as input the first data structure, the second data structure characterizing (i) detected anomalies and (ii) causes of the detected anomalies. The at least one processing device is further configured to perform remediation actions, selected based on the second data structure, for the information technology asset.

### BACKGROUND

Support platforms may be utilized to provide various services for sets of managed computing devices. Such services may include, for example, troubleshooting and remediation of issues encountered on computing devices managed by a support platform. This may include periodically collecting information on the state of the managed computing devices, and using such information for troubleshooting and remediation of the issues. Such troubleshooting and remediation may include receiving requests to provide servicing of hardware and software components of computing devices. For example, users of computing devices may submit service requests to a support platform to troubleshoot and remediate issues with hardware and software components of computing devices. Such requests may be for servicing under a warranty or other type of service contract offered by the support platform to users of the computing devices. Support platforms may also provide functionality for testing managed computing devices.

### SUMMARY

Illustrative embodiments of the present disclosure provide techniques for machine learning-based system log anomaly detection and remediation.

In one embodiment, an apparatus comprises at least one processing device comprising a processor coupled to a memory. The at least one processing device is configured to generate a first data structure, the first data structure comprising a numerical representation of content of a given system log associated with at least one information technology asset, and to determine, utilizing the first data structure, a given one of a plurality of system log clusters to which the given system log belongs, each of the plurality of system log clusters comprising a set of non-anomalous system logs. The at least one processing device is also configured to select, from the given system log cluster, a subset of a given set of non-anomalous system logs which are part of the given system log cluster, and to perform contextual contrastive tuning of at least one machine learning model utilizing the selected subset of non-anomalous system logs. The at least one processing device is further configured to generate a second data structure utilizing the tuned at least one machine learning model, the tuned at least one machine learning model taking as input the first data structure, the second data structure characterizing (i) one or more anomalies detected in the given system log and (ii) one or more causes of at least one of the one or more anomalies detected in the given system log. The at least one processing device is further configured to perform one or more remediation actions for the at least one information technology asset, the one or more remediation actions being selected based at least in part on the second data structure.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based system log anomaly detection and remediation in an illustrative embodiment.

FIG. 2 is a flow diagram of an exemplary process for machine learning-based system log anomaly detection and remediation in an illustrative embodiment.

FIG. 3 shows a format of a block of a system log in an illustrative embodiment.

FIG. 4 shows a system flow for contextual data transformation in an illustrative embodiment.

FIG. 5 shows a system implementing an inference pipeline for anomaly detection and reasoning in system logs utilizing a fine-tuned machine learning model in an illustrative embodiment.

FIG. 6 shows an example transformation of an input message code sequence into a fixed length vector in an illustrative embodiment.

FIG. 7 shows a plot of clustering of vectorized message code sequences in an illustrative embodiment.

FIG. 8 shows an example of a syntactical data block including a message code, a message description and a message severity in an illustrative embodiment.

FIG. 9 shows an example of a contextual data block including an anomalous entry, an anomaly label, a context, a message code sequence, and an anomaly reason in an illustrative embodiment.

FIG. 10 shows a table of results of performing anomaly detection on a set of system logs in an illustrative embodiment.

FIG. 11 shows an example of an output data block including a context, a message code sequence, and anomalous entry, an anomaly label, and anomaly reason in an illustrative embodiment.

FIGS. 12 and 13 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

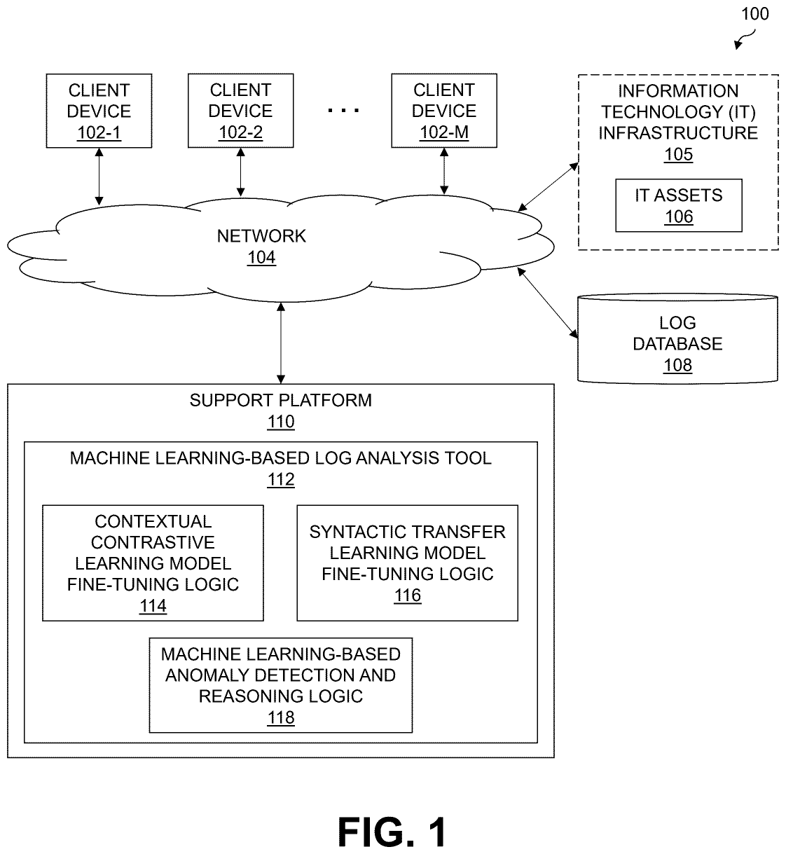

FIG. 1 shows an information processing system 100 configured in accordance with an illustrative embodiment. The information processing system 100 is assumed to be built on at least one processing platform and provides functionality for machine learning-based system log anomaly detection, reasoning and remediation. The information processing system 100 includes a set of client devices 102-1, 102-2, . . . 102-M (collectively, client devices 102) which are coupled to a network 104. Also coupled to the network 104 is an information technology (IT) infrastructure 105 comprising one or more IT assets 106, a log database 108, and a support platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the support platform 110 is used for an enterprise system. For example, an enterprise may subscribe to or otherwise utilize the support platform 110 for managing IT assets 106 of the IT infrastructure 105 operated by that enterprise. Users of the enterprise associated with different ones of the client devices 102 may utilize the support platform 110 in order to manage problems or other issues which are encountered on different ones of the IT assets 106. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The log database 108 is configured to store and record various information that is utilized by the support platform 110. Such information may include, for example, logs that are collected from or otherwise associated with the IT assets 106 of the IT infrastructure 105. The information may include historical logs and their associated classifications (e.g., anomalous or not), any actions taken to remediate issues raised in the historical logs, etc. The log database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the support platform 110, as well as to support communication between the support platform 110 and other related systems and devices not explicitly shown.

The support platform 110 may be provided as a cloud service that is accessible by one or more of the client devices 102 to allow users thereof to manage servicing of the IT assets 106 of the IT infrastructure 105, the client devices 102 themselves, other products which are serviced by the support platform 110, etc. The client devices 102 may be configured to access or otherwise utilize the support platform 110 to perform anomaly detection, reasoning and remediation operations for different ones of the IT assets 106 (or other products, such as the client devices 102 themselves). In some embodiments, the client devices 102 are assumed to be associated with system administrators, IT managers, support engineers or other authorized personnel responsible for managing or performing servicing of the IT assets 106. In some embodiments, the IT assets 106 of the IT infrastructure 105 are owned or operated by the same enterprise that operates the support platform 110. In other embodiments, the IT assets 106 of the IT infrastructure 105 may be owned or operated by one or more enterprises different than the enterprise which operates the support platform 110 (e.g., a first enterprise provides support for multiple different customers, business, etc.). Various other examples are possible.

In some embodiments, the client devices 102 and/or the IT assets 106 of the IT infrastructure 105 may implement host agents that are configured for automated transmission of information with the support platform 110. It should be noted that a “host agent” as this term is generally used herein may comprise an automated entity, such as a software entity running on a processing device. Accordingly, a host agent need not be a human entity.

The support platform 110 in the FIG. 1 embodiment is assumed to be implemented using at least one processing device. Each such processing device generally comprises at least one processor and an associated memory, and implements one or more functional modules or logic for controlling certain features of the support platform 110. In the FIG. 1 embodiment, the support platform 110 implements a machine learning-based log analysis tool 112. The machine learning-based log analysis tool 112 comprises contextual contrastive learning model fine-tuning logic 114, syntactic transfer learning model fine-tuning logic 116 and machine learning-based anomaly detection and reasoning logic 118. The contextual contrastive learning model fine-tuning logic 114 is configured to fine-tune a machine learning model utilized for anomaly detection and reasoning utilizing context provided by non-anomalous system logs selected from a cluster of system logs which is closest to a given system log being analyzed. As used herein, references to “fine-tuning” a machine learning model include performing transfer learning for the machine learning model, and may include adjusting parameters (e.g., weights, biases, etc.) of a pre-trained machine learning model using additional data. For example, the selected non-anomalous system logs may provide additional data that is used for fine-tuning an already trained machine learning model (e.g., a large language model (LLM)) that is utilized for anomaly detection and reasoning. Fine-tuning is an example of what is more generally referred to as tuning a machine learning model, where tuning the machine learning model adapts a model for some task-specific or domain-specific dataset (e.g., such as tuning or fine-tuning an anomaly detection and reasoning LLM utilizing selected non-anomalous system logs). The syntactic transfer learning model fine-tuning logic 116 is configured to further fine-tune the machine learning model utilized for anomaly detection and reasoning based on system logs from a same domain as the given system log being analyzed (e.g., so that the machine learning model “learns” the terminology of the system logs for a particular domain). The machine learning-based anomaly detection and reasoning logic 118 is configured to analyze the given system log utilizing the fine-tuned machine learning model, which may comprise a large language model (LLM). This may be done by vectoring a sequence of message codes in the given system log, determining a cluster of system logs to which the given system log is closest, utilizing the contextual contrastive learning model fine-tuning logic 114 to select samples of non-anomalous system logs from the determined cluster to fine-tune the machine learning model, and then performing inference (e.g., anomaly detection and anomaly reasoning) for the given system log.

At least portions of the machine learning-based log analysis tool 112, the contextual contrastive learning model fine-tuning logic 114, the syntactic transfer learning model fine-tuning logic 116 and the machine learning-based anomaly detection and reasoning logic 118 may be implemented at least in part in the form of software that is stored in memory and executed by a processor.

It is to be appreciated that the particular arrangement of the client devices 102, the IT infrastructure 105, the log database 108 and the support platform 110 illustrated in the FIG. 1 embodiment is presented by way of example only, and alternative arrangements can be used in other embodiments. As discussed above, for example, the support platform 110 (or portions of components thereof, such as one or more of the machine learning-based log analysis tool 112, the contextual contrastive learning model fine-tuning logic 114, the syntactic transfer learning model fine-tuning logic 116 and the machine learning-based anomaly detection and reasoning logic 118) may in some embodiments be implemented internal to one or more of the client devices 102 and/or the IT infrastructure 105.

The support platform 110 and other portions of the information processing system 100, as will be described in further detail below, may be part of cloud infrastructure.

The support platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the log database 108 and the support platform 110 or components thereof (e.g., the machine learning-based log analysis tool 112, the contextual contrastive learning model fine-tuning logic 114, the syntactic transfer learning model fine-tuning logic 116 and the machine learning-based anomaly detection and reasoning logic 118) may be implemented on respective distinct processing platforms, although numerous other arrangements are possible. For example, in some embodiments at least portions of the support platform 110 and one or more of the client devices 102, the IT infrastructure 105, the IT assets 106 and/or the log database 108 are implemented on the same processing platform. A given client device (e.g., 102-1) can therefore be implemented at least in part within at least one processing platform that implements at least a portion of the support platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the log database 108 and the support platform 110, or portions or components thereof, to reside in different data centers. Numerous other distributed implementations are possible. The support platform 110 can also be implemented in a distributed manner across multiple data centers.

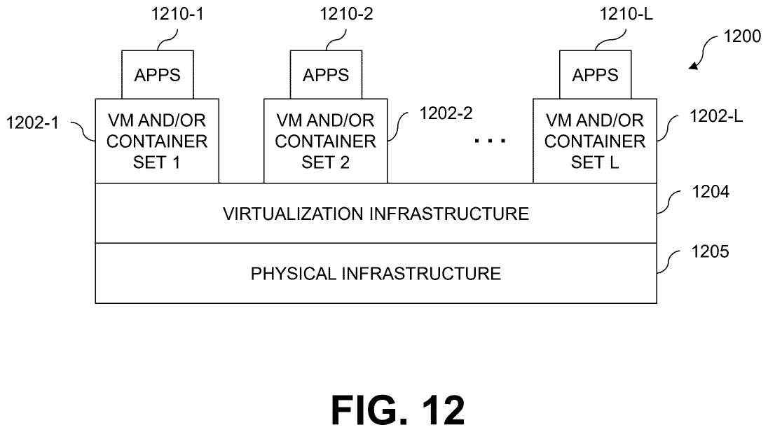

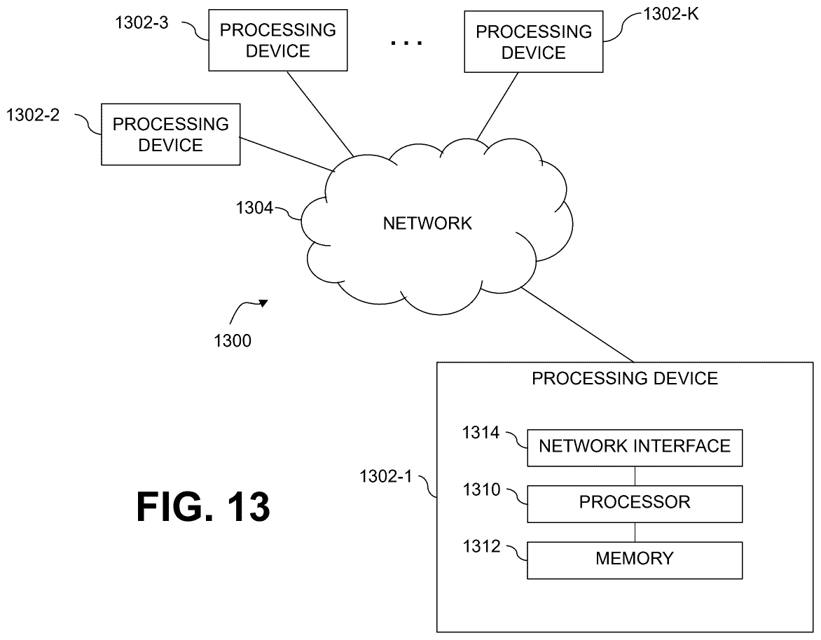

Additional examples of processing platforms utilized to implement the support platform 110 and other components of the information processing system 100 in illustrative embodiments will be described in more detail below in conjunction with FIGS. 12 and 13.

It is to be understood that the particular set of elements shown in FIG. 1 for machine learning-based system log anomaly detection, reasoning and remediation is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

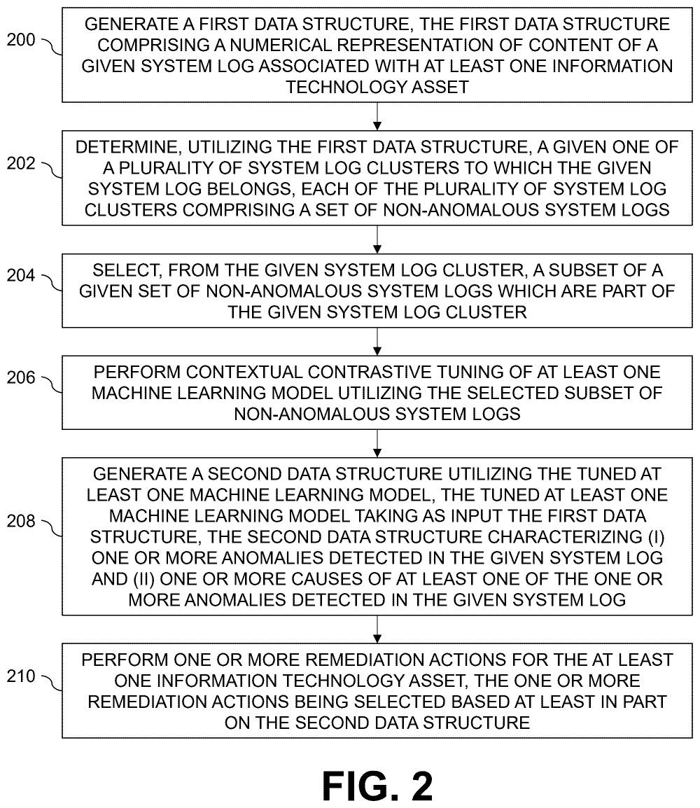

An exemplary process for machine learning-based system log anomaly detection and remediation will now be described in more detail with reference to the flow diagram of FIG. 2. It is to be understood that this particular process is only an example, and that additional or alternative processes for machine learning-based system log anomaly detection and remediation may be used in other embodiments.

In this embodiment, the process includes steps 200 through 210. These steps are assumed to be performed by the support platform 110 utilizing the machine learning-based log analysis tool 112, the contextual contrastive learning model fine-tuning logic 114, the syntactic transfer learning model fine-tuning logic 116 and the machine learning-based anomaly detection and reasoning logic 118. The process begins with step 200, generating a first data structure, the first data structure comprising a numerical representation of content of a given system log associated with at least one IT asset. The first data structure may comprise a vectorized representation of a sequence of message codes of the given system log. Step 200 may include applying pre-processing to the given system log to remove duplicate consecutive message codes in the sequence of message codes. The pre-processing applied to the given system log may also or alternatively include removing one or more stop message codes from the sequence of message codes. The one or more stop message codes may be identified utilizing term frequency-inverse document frequency (TF-IDF) of message codes in a plurality of system logs.

In step 202, a given one of a plurality of system log clusters to which the given system log belongs is determined utilizing the first data structure. Each of the plurality of system log clusters comprises a set of non-anomalous system logs. Step 202 may include computing a Euclidean distance between the numerical representation of the content of the given system log and cluster centroids of the plurality of system log clusters. The plurality of system log clusters may be generated based at least in part on applying a clustering algorithm to numerical representations of the sets of non-anomalous system logs. The clustering algorithm may comprise a Balanced Iterative Reducing and Clustering Using Hierarchies (BIRCH) clustering algorithm.

In step 204, a subset of a given set of non-anomalous system logs which are part of the given system log cluster are selected. Step 204 may include selecting a designated threshold number of the given set of non-anomalous system logs closest to a cluster centroid of the given system log cluster.

In step 206, contextual contrastive tuning of at least one machine learning model is performed utilizing the selected subset of non-anomalous system logs. The at least one machine learning model may comprise a large language model (LLM). In some embodiments, the FIG. 2 process also includes performing anomaly detection-tuning of the at least one machine learning model utilizing anomaly reasons for anomalous sequences of message code sequences learned from historical anomalous system logs. The FIG. 2 process may also or alternatively include performing syntactical tuning of the at least one machine learning model for a given domain associated with the at least one IT asset. Performing the syntactical tuning of the at least one machine learning model may be based at least in part on analysis of unique message code combinations in a plurality of system logs produced by one or more IT assets associated with the given domain. The given domain may comprise message code terminology used in message codes of system logs produced by the at least one IT asset.

In step 208, a second data structure is generated utilizing the tuned at least one machine learning model. The tuned at least one machine learning model takes as input the first data structure. The second data structure characterizes (i) one or more anomalies detected in the given system log and (ii) one or more causes of at least one of the one or more anomalies detected in the given system log. As used herein, the term “data structure” is intended to be construed broadly, and may include one or more tables, arrays, numerical or other representations of data, etc. Further, the first and second data structures described herein may be different portions of a same larger data structure.

In step 210, one or more remediation actions are performed for the at least one IT asset, the one or more remediation actions being selected based at least in part on the second data structure. The remediation actions may include, for example, applying fixes or patches to hardware, software or firmware of the at least one IT asset, modifying the hardware, software or firmware configuration of the at least one IT asset, etc.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes for different logs, for different IT assets, for different issues encountered on one or more IT assets, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Modernization and innovation has become a key factor for any organization to achieve its goals. With the current pace of development, the efforts that go into any activity towards modernization or innovation of any product or service is huge, and the cost that goes into these is also tremendous. The success of products and services may be based at least in part on how small the performance gap is between user expectation and actual performance. To narrow the performance gap, organizations may expend significant resources in testing products or services to check whether the expected performance can be achieved.

When IT enterprise products such as servers, storage systems, etc. are considered, testing is an important aspect of product development as it provides many insights about performance which determines how well products perform. Especially for servers and other IT assets which are customized for particular user needs, extensive testing may be done to ensure top performance. Test engineers construct test cases to check whether intended process results are achieved. Test cases may fall under various different categories, including: component testing which provides a comprehensive report on the functioning of hardware, software and firmware parts and features within IT assets; node testing to compute network performance capabilities; offer or enterprise system testing to mimic user scenarios for customized IT assets; etc.

Due to several checks on IT assets, there may be a large number of test cases (e.g., about 100,000 test cases for servers) that are to be run on the IT assets to validate performance, resilience, reliability, etc. Each of the test cases may generate system logs which provide information about each test run, which can be used by test engineers or other support staff to validate the success of each run. In some embodiments, the system logs comprise Lifecycle Controller (LC) logs produced by a Dell Lifecycle Controller, which provides advanced embedded system management technology enabling remote server or other IT asset management using an integrated controller (e.g., an integrated Dell Remote Access Controller (iDRAC)). The Dell Lifecycle Controller, for example, may be used to update firmware using a local or Dell-based firmware repository. The LC or other system logs may contain rich information, but may include thousands of lines of information including message codes, message descriptions, a severity index, etc. Analyzing individual log files becomes increasingly difficult with the increase in the number of test cases which are executed, and is even more difficult to view and find any anomalies (if present) in individual test case log files.

In the processing of analyzing LC or other system logs, due to human error there are chances to miss out on some important issues while running some test cases. These issues might not be relevant for the current test case run, but may represent an anomalous issue for the overall performance of an IT asset such as a server. Using anomaly detection algorithms, a syntactical anomaly using the message code sequence can be found. However, within the context of a current test case run, understanding the issue from just the syntax will be difficult and time-consuming for test engineers to figure out the issues.

Illustrative embodiments provide technical solutions which address these and other technical problems by implementing a machine learning-based approach for determining anomalous sequences within system logs (e.g., produced by running test cases, produced during execution or operation of IT assets within production environments, etc.). In some embodiments, the machine learning-based approach utilizes a Large Language Model (LLM), where the LLM is fine-tuned using available historical information (e.g., internal test cases and manually detected anomalies which are stored in an internal database, such as the log database 108, which may be implemented as an elastic search database). Through the fine-tuning process, the LLM is made aware of the internal syntax used by a particular entity (e.g., for some set of IT assets). The LLM is further made aware of the context/semantics of the runtime environment (e.g., test case scenarios) which provides for improved and more robust anomaly detection. The technical solutions thus introduce a novel approach for combining Contextual Contrastive Learning for Improved Few-Shot (e.g., contrasting few-shot (CFS) sample generation) and fine-tuning of a machine learning model (e.g., an LLM) to provide improved results. The technical solutions may be applied in testing environments (e.g., non-production operating environments) for internal test analysis, as well as in non-testing environments (e.g., production operating environments) for user issue analysis of generated logs. Advantageously, the LLM-based technical solution used in some embodiments exploits the contextual and syntactical learning capabilities of an LLM. The improved anomaly detection can also advantageously allow test engineers to make more informed decisions regarding execution of test cases to make servers or other IT assets more robust and resilient.

The success of any product or service (e.g., an IT asset) relies on performance and error-free functionalities. For making sure of this success, organizations, enterprises and other entities may expend significant resources for testing products and services to check whether performance of IT assets meets with user expectations and/or guarantees (e.g., service level agreements (SLAs)). Testing provides knowledge to discover issues before IT assets reach users. Fixing issues during testing improves IT assets and avoids potentially catastrophic implications of issues which are encountered during operation of IT assets by users (e.g., in a production or other non-testing environment).

In the enterprise IT product space for IT assets such as servers, storage systems, etc., testing may be conducted in a very stringent environment by a group of specialists or test engineers. For example, a server or other IT asset may be customized to satisfy the needs or requirements of different users, and thus the type of testing carried out will differ accordingly. For example, testing may include some basic checks like power requirements, startup sequence, etc. which may be common across servers or other IT assets customized for different users. Testing may also include a number of test cases which are configured to evaluate the particular customized functioning or features of the servers or other IT assets for different users. The success of testing may be based on or judged by the number of issues which were detected and resolved. Issue detection is done by a process carried out by running a set of instructions referred to as test cases. Test cases include sequences of steps for determining the correctness of functionality or features of a server or other IT asset. Test engineers or specialists, with their past experience, may select a number of test cases which are relevant for evaluating required functionality of features of a server or other IT asset.

The test cases which are run assure the quality of servers or other IT assets before they are delivered to users. Testing is an important part of IT asset development, and thus a lot of importance is given in the selection of valid test cases. Conventional approaches which rely on manual selection of test cases and logs produced therefrom, however, may suffer from human error where test cases may lead to unprecedented output which could have been bypassed in the process. For example, a given test case run may pass for a given feature, but there may be an anomalous sub-sequence generated in LC or other system logs which, when identified, may help the test engineer to execute other related test cases in the pursuit of catching probable defects.

To enable identification of anomalies, the technical solutions described herein provide a framework for detecting such unprecedented anomalies in system logs using a machine learning model (e.g., an LLM) that is fine-tuned (e.g., based on internal test cases). LLMs are a type of generative deep learning model capable of multiple contextual understanding. The use of an LLM allows for understanding the syntactical and the contextual significance of messages and/or error codes within the description of system logs to thus identify anomalies with improved accuracy, and to give a proper understanding of anomaly reasoning to assist in rectifying the identified anomalies. Some embodiments utilize Contextual Contrastive Learning and fine-tuning of an LLM to address various technical problems of conventional approaches. Some embodiments provide technical solutions for anomaly detection in system logs by leveraging historical system logs using LLMs with the application of contextual and syntactic learning.

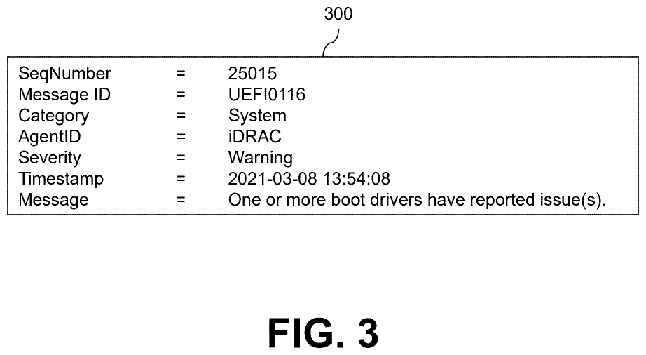

The technical solutions may start with data in the form or LC or other system logs. The system logs may be generated, for example, through the execution of test cases in servers or other IT assets that are under testing consideration. The test cases may include lists of instructions that test different functionality of servers or other IT assets. Each system log may contain various blocks (e.g., tens, hundreds, etc.) based on the test case that is executed. FIG. 3 shows a log format 300 of a block of a system log. In some embodiments, the technical solutions provide for contextual data transformation, machine learning model fine-tuning, and a machine learning-based inference pipeline.

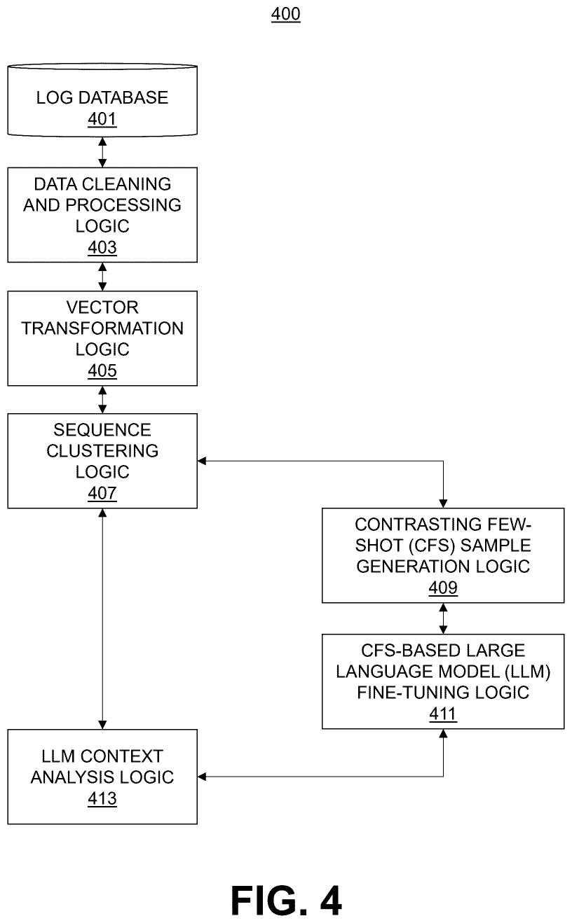

Contextual data transformation seeks to provide a machine learning model (e.g., an LLM) with dynamic context that enhances anomaly detection. FIG. 4 shows a system flow 400 for contextual data transformation, which starts with historical system logs stored in a log database 401 (e.g., which may be implemented as an Elastic Search database). From the log database 401, logs from successful test cases may be selected. The reason behind this selection is to provide context of standard non-anomalous example log sequences to the machine learning model (e.g., the LLM) for improved anomaly detection. This is referred to as Contextual Contrastive Learning for improved Few-Shot. This is contrasted with in-context learning of an LLM, where few-shot examples are given to learn and answer the LLM instruction in the same format. The technical solutions take an opposite approach, where the contextual examples are of system logs that include non-problematic or non-anomalous sequences.

From the list of standard log files, the data cleaning and processing logic 403 extracts message code sequences and applies various data cleaning and processing. For example, the message codes may be converted into a standard format (e.g., like all capital letters) and other normalization steps. Adding to this, consecutive message codes are checked whether they are the same or not. If the same message code occurs twice consecutively, one instance is removed. A term frequency inverse document frequency (TF-IDF) process may be employed to remove inferred stop message codes (e.g., analogous to stop words). This is carried out as part of noise removal processing. The data cleaning and processing logic 403 thus generates a cleaned-up message code sequence for each of the log files. Each of the generated sequences is then passed through the vector transformation logic 405 which converts the sequences into artificial intelligence (AI)/machine learning (ML) understandable vectors of constant size. The vector transformation logic 405 generalizes the sequence length as each of the log files may vary in the number of message codes based on the purpose of the test cases. The vector transformation logic 405 may utilize a Seq2Vec technique for vector transformation which is configured to convert a variable length sequence into a constant-sized vector.

Following the standardization of the sequences into machine-understandable vectors, sequence clustering logic 407 is executed. The sequence clustering logic 407 may pass the vectorized sequences through a Balanced Iterative Reducing and Clustering Using Hierarchies (BIRCH) or other clustering algorithm. The BIRCH clustering algorithm is selected in some embodiments for its scalability in dealing with large datasets, and its capability for handling noise and outliers in the data. Also, as BIRCH clustering is an extension of hierarchical clustering, it can cluster sequential data with more precision.

Contrasting Few-Shot (CFS) sample generation logic 409 is then applied to identify representative cases from each system log pattern or cluster. The result of the sequence clustering logic 407 is to find varied patterns in existing non-anomalous system log samples. The CFS sample generation logic 409 identifies the most representative samples (e.g., a few shots, referred to as CFS samples) within each pattern type or cluster. These representative samples are identified from ones of the system log samples which are closest to the cluster centroid. In some embodiments, about 5 non-anomalous samples which are closest to the cluster centroid are identified as the “few shots” or CFS samples based on inferring the cluster that a given system log to be analyzed belongs to. This is done by fetching the Seq2Vec embeddings of the given system log being analyzed, and then computing its Euclidean distance between the centroids of each of the clusters. The closest distance is used to determine which cluster the CFS samples are fetched from. The CFS-based LLM fine-tuning logic 411 is then employed to build a fine-tuned model that mimics the methodology that a human would apply. The CFS samples and down-stream fine-tuning processing strengthens the hints provided to the machine learning model (e.g., the LLM). The CFS samples assist in determining if there is something “off” (e.g., an anomaly) in a current system log being analyzed.

The CFS-based LLM fine-tuning logic 411 is performed as the base LLM does not possess domain knowledge about the system logs' message codes or the test case anomaly detection. The fine-tuning process is done using historical system logs available in the log database 401, which holds a repository of system logs which do and do not have anomalies. The fine-tuning process includes Contextual Contrastive Learning for Improved Few-Shot examples (e.g., CFS samples). The fine-tuning makes the LLM aware of the message codes and anomalous subsequences of message codes. The CFS-based LLM fine-tuning logic 411 may execute in two portions: (1) fine-tuning for message code understanding and (2) fine-tuning for anomaly detection. The fine-tuning for message code understanding makes the LLM aware of the domain, and may be performed on all unique message code combinations. From the historical system logs, message identifiers (IDs), message description, severity and other information may be collected. This collected data is utilized for fine-tuning the LLM and establishing a syntactical understanding of the specific domain under consideration. The fine-tuning on anomaly detection uses the syntactical and contextual resulting capabilities of the LLM utilized for anomaly detection.

Fine-tuning the LLM based on the sequential nature of system log messages is important for making the LLM gain contextual knowledge on various sequential patterns present in the system logs. The same LLM which is fine-tuned for message code understanding is again fine-tuned for anomaly detection. The data used for fine-tuning includes the message codes from historical system logs which include both proper (e.g., non-anomalous) and anomalous sequences. For each message code sequence, a number (e.g., 5) of non-anomalous samples are identified using the sequence clustering logic 407 and the CFS sample generation logic 409 and added as context to the LLM model to give the LLM CFS samples. Along with this information, the reasons for anomalies are added by the CFS-based LLM fine-tuning logic 411 as responses for anomalous sequences. This establishes a complete contextual understanding for the LLM. The LLM context analysis logic 413 is then applied to determine whether system logs to be analyzed include anomalies.

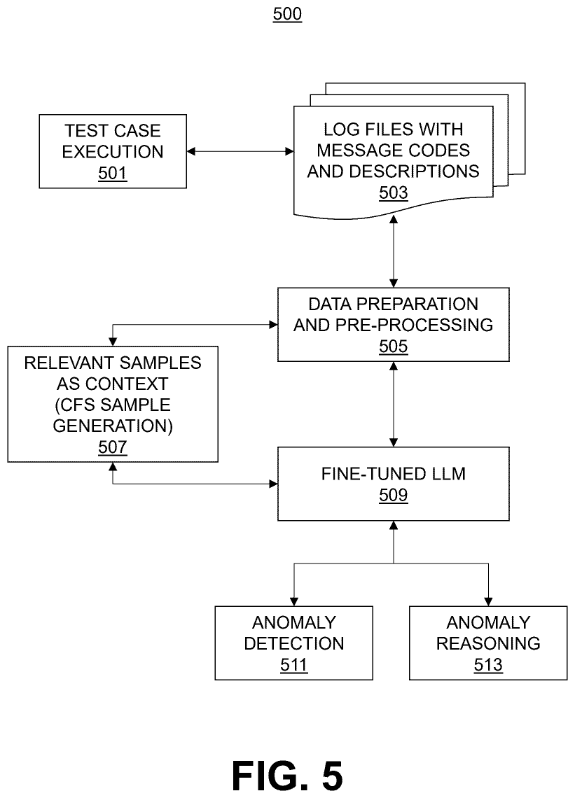

An inference pipeline will now be described with respect to the system 500 of FIG. 5. The inference pipeline includes performing anomaly detection on unseen system logs (e.g., for test cases being run for a given IT asset) to monitor the performance of the LLM. The inference pipeline begins with test case execution in block 501 (e.g., for an IT asset that is to be tested for certain functionality), which produces a set of log files 503 with message codes and descriptions.) Upon execution of the test cases in block 501, system logs or log files 503 are generated which may include multiple blocks of information mentioning the process followed during the test case execution in block 501. Each block may include a message ID or message code, a message description, a severity, etc. Data preparation and pre-processing is then applied in block 505 to make each of the log files 503 similar to the input data format used for fine-tuning of the LLM. The data preparation and pre-processing of block 505 is executed to collect all message code entries from the system logs, to create a sequence of message code IDs, and to remove consecutive repeating message code IDs. TF-IDF may be applied to remove stop-message events (e.g., analogous to stop words). This prepares the sequences into a format suitable for being fed into a fine-tuned LLM 509.

Before the fine-tuned LLM 509 is executed to perform anomaly detection 511 and anomaly reasoning 513 for a log sequence of a given log being analyzed, relevant context samples 507 are collected (e.g., CFS sample generation) by matching the log sequence of the given log with pre-defined clusters created via Contextual Data Transformation. As discussed above, the CFS samples provide “hints” to the fine-tuned LLM to enable anomaly detection 511 and anomaly reasoning 513 to be performed with greater accuracy. A designated number (e.g., 5) of non-anomalous cluster-based samples (e.g., the CFS samples) are collected and used for contextual contrastive learning of the fine-tuned LLM 509. With the context collected and the system log being analyzed being processed (e.g., via the data preparation and pre-processing in block 505), the fine-tuned LLM 509 is invoked and used for anomaly detection 511 (e.g., detection of anomalous entries or subsequences in the system log being analyzed). The fine-tuned LLM 509 provides anomaly detection 511 (e.g., indication of whether any anomalies are present) along with anomaly reasoning 513 (e.g., which may be provided to a test engineer or other processing for post-test check analysis and corrective actions). The anomaly reasoning 513 may also be utilized for technical support and user issue resolution processes.

The inference pipeline shown in the system 500 of FIG. 5 may be used for achieving an automated and AI-driven enterprise level server, storage system or other IT asset post-test check analysis, as well as for issue detection and remediation in non-testing environments. The inference pipeline shown in the system 500 of FIG. 5 may also be applied for user issue resolution processing and integration with various services (e.g., user self-serve processing, Dell CloudIQ, technical support, etc.). The Contextual Contrastive Learning for Improved Few-Shot processing advantageously provides a novel and improved approach for anomaly detection in system logs using clustering-based pattern matching, to provide contrasting few-shot hints (e.g., CFS samples). The carefully selected few-shot examples serve as typical non-anomalous instances, enabling the fine-tuned LLM 509 to assess a current system log (e.g., a test log file) being analyzed to identify potential anomalies.

The technical solutions advantageously equip the LLM or other machine learning model utilized for anomaly detection with essential hints to distinguish the system log being analyzed from typical non-anomalous instances. By coupling this approach with model fine-tuning, illustrative embodiments provide a novel and highly precise approach to anomaly detection, reasoning and remediation. The machine learning-based approach mirrors how humans identify anomalies, comparing a system log to be analyzed with sample typical non-anomalous data (e.g., context) and learning the comparison over time and over many samples (e.g., fine-tuning). The unique approach for fine-tuning the LLM or other machine learning model on the message codes, message descriptions, severity and other parameters separately before fine-tuning for anomaly detection provides a number of advantages. First, this makes the machine learning model aware of the domain which is needed for any processing of information using the machine learning model. Second, this allows saving of context length for the inference. Third, this allows for adding the contextual reference to the machine learning model to assist in proper anomaly detection. The technical solutions also advantageously provide anomaly reasoning, as the machine learning model (e.g., the LLM) may be trained with reasoning capability in addition to or as part of anomaly detection. The combination of anomaly detection and anomaly reasoning on why a detected sub-sequence is an anomaly adds value for understanding the situation, and for selecting and implementing suitable remediation action.

An example implementation of the inference pipeline shown in the system 500 of FIG. 5 will now be described. This example implementation is based on an experiment using internal testing logs generated by running test cases on servers. The testing logs are collected as part of the server validation and are stored in an elastic storage database. About 2000 of the of the testing logs were collected for experimentation. Among the 2000, 60 of the testing logs had some anomalous entry or sub-sequence of message codes. This was a class imbalanced dataset to the tune of 3:97. Apart from this, 100 other testing logs were selected with 20 having anomalies for the purpose of testing. One consideration for the experiment is that only testing logs which had less than 500 message code sequences were selected.

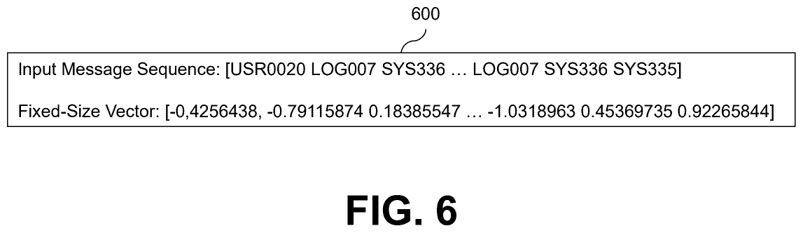

Out of the collected 2000 testing logs, for the purpose of context data, the 60 anomalous testing logs were excluded and then passed through the transformation steps. From all the testing logs, the message codes were extracted in the same sequence as executed during the associated test case run. From the sequence, consecutive repetitions of the same message codes are removed. On this, TF-IDF based noise removal is carried out to remove frequently occurring message codes. FIG. 6 illustrates an example 600 of Seq2Vec transformation, which converts an input message sequence (e.g., of message codes) into a fixed-size vector of numerical values.

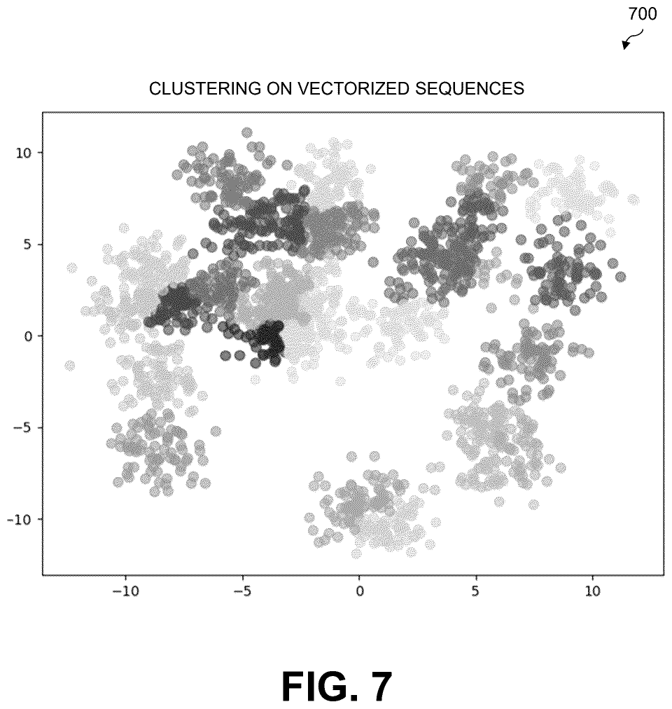

Following the data processing, the 1940 testing logs are subject to a clustering process (e.g., BIRCH clustering) to get all unique patterns of sequences using Seq2Vec transformation through which vectors of constant length (e.g., of 1024) were obtained. Upon clustering the sample sequences using the vectorized sequences, a total of 27 clusters were obtained. For each cluster, a designated number (e.g., 5) of non-anomalous sequences closest to the cluster centroid were selected. FIG. 7 shows a plot 700 of clustering on vectorized sequences (e.g., obtained utilizing a BIRCH clustering algorithm). The same clustering is also carried out on the testing dataset to identify the designated number (e.g., 5) of non-anomalous log sequences provided to the machine learning model (e.g., the LLM) for fine-tuning.

The model fine-tuning was carried out to prepare the machine learning model (e.g., the LLM) for the specific task of anomaly detection on the testing logs. In some embodiments, the machine learning model comprises a Falcon 40B LLM. The fine-tuning of the LLM is done by leveraging QLora-based 4-bit quantization. This allows for conducting the experiment on a limited graphical processing unit (GPU) environment. Falcon 40B, which is an open source commercially usable model, is utilized and trained on internal domain-specific data for fine-tuning. The fine-tuning is performed in two portions.

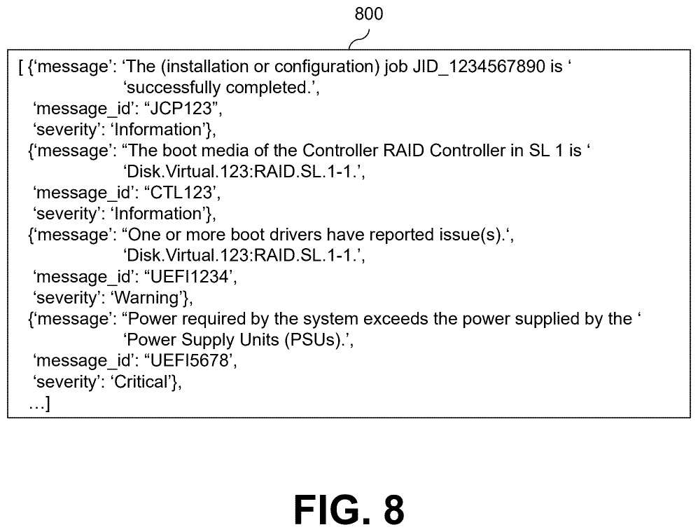

First, the machine learning model is fine-tuned to get an understanding of the internal terminology (e.g., the message codes with associated message descriptions, severity, etc.). This understanding is important to make the machine learning model syntactically aware of the internal processes and terminology. For this, a dictionary with a total of 8821 syntactical data blocks was created, with each data block including a message code or ID, a message description, and a message severity. These syntactical data blocks are utilized for fine-tuning the machine learning model. FIG. 8 shows an example 800 of a syntactical data block.

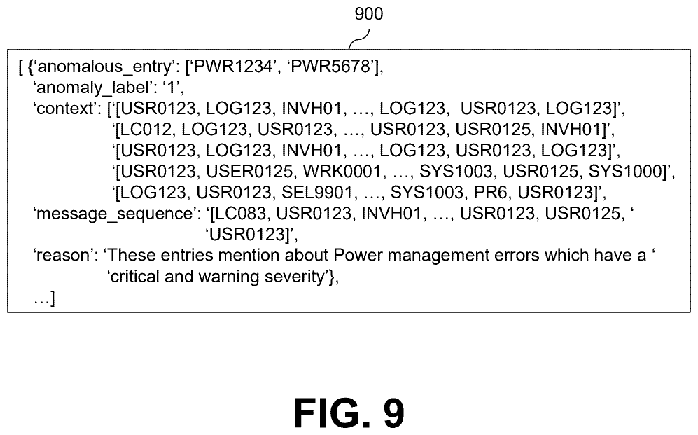

Second, the machine learning model is fine-tuned on anomaly detection. The message code sequences from the collected testing log files were generated, and the context was linked for each sequence. For anomalous sequences, the message codes that are erroneously placed are listed and added along with the reasoning behind why those message codes are anomalous. Similarly, for the non-anomalous sequences, the anomaly list was left empty. For both these sequences, the extracted context is added to the list. This combines to form the contextual data blocks, with the contextual data blocks being utilized for fine-tuning the machine learning model to get aligned with the anomaly detection. FIG. 9 shows an example 900 of a contextual data block.

For the anomaly detection on a test sequence, the data was curated in a manner similar to that of the contextual data blocks. The formatted data is passed to the fine-tuned machine learning model (e.g., the LLM), and the model output is verified and compared with that of other types of models such as Sequence Graph Transform (SGT)-based anomaly detection, Log Anomaly Detection via Bidirectional Encoder Representations from Transformers (LogBERT), etc.

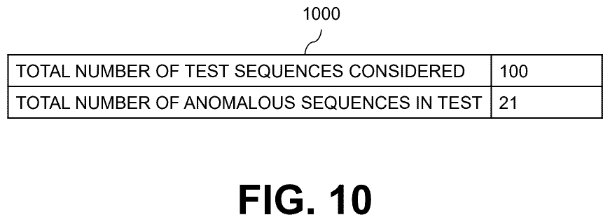

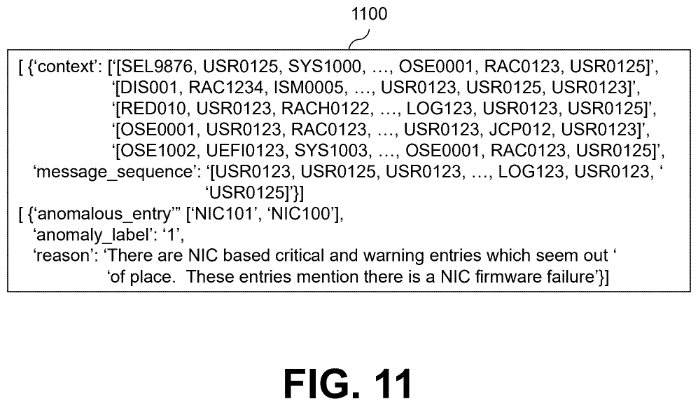

FIG. 10 shows a table 1000 illustrating the experiment results (e.g., the total number of test sequences considered and the total number of anomalous sequences in the test). With the testing sequence, it was observed that 16 out of the 21 were rightly identified by the machine learning model as having anomalies, and 12 of the 16 gave the right anomalous sequence as the output. When these results are compared with those of other techniques, significant improvements are observed. For example, LogBERT only identified 9 out of the 21 having anomalies without identifying the anomalous subsequences, and SGT-based anomaly detection only identified 8 out of the 21 having anomalies with 4 anomalous sub-sequences being identified. It should be further noted that conventional approaches like LogBERT and SGT-based anomaly detection are not able to provide anomaly reasoning. Thus, the LLM-based approach utilized in some embodiments provides various technical advantages for analyzing log data. FIG. 11 shows an example 1100 of sample anomalous output. In the example of FIG. 11, the test case which was executed related to iDRAC Watchdog Reset with a message sequence of length 357 message codes. This sequence had a sub-sequence of 2 message codes where were not meant for this test case. When passed to the LLM along with the context sequences, the LLM was correctly able to detect the anomalies (‘NIC101’, ‘NIC100’) which represent network interface card (NIC)-based errors which should not have appeared in the test case output. Along with the anomaly detection, a valid anomaly reasoning was also generated by the LLM.

Conventional approaches may rely on manual identification of anomalies in system logs, univariate anomaly detection, SGT-based anomaly detection, LogBERT anomaly detection, etc. The technical solutions described herein provide an ensemble of Contextual Contrastive Learning for Improved Few-Shot and fine-tuning approaches which equipe a system log anomaly detection machine learning model (e.g., an LLM) with essential hints (e.g., in the form of CFS samples) to distinguish an under-consideration system log or log file from typical non-anomalous instances. By coupling this approach with fine-tuning, the technical solutions are able to implement a novel and highly precise approach for log anomaly identification. This process mirrors how humans identify anomalies through comparison of an under-consideration system log with sample typical non-anomalous data (e.g., context provided by CFS samples) and learning this comparison process over time and over many samples (e.g., fine-tuning).

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based system log anomaly detection and remediation will now be described in greater detail with reference to FIGS. 12 and 13. Although described in the context of system 100, these platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that may be utilized to implement at least a portion of the information processing system 100 in FIG. 1. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 may comprise respective VMs, respective sets of one or more containers, or respective sets of one or more containers running in VMs.

In some implementations of the FIG. 12 embodiment, the VMs/container sets 1202 comprise respective VMs implemented using virtualization infrastructure 1204 that comprises at least one hypervisor. A hypervisor platform may be used to implement a hypervisor within the virtualization infrastructure 1204, where the hypervisor platform has an associated virtual infrastructure management system. The underlying physical machines may comprise one or more distributed processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises a portion of system 100 and includes a plurality of processing devices, denoted 1302-1, 1302-2, 1302-3, . . . 1302-K, which communicate with one another over a network 1304.

The network 1304 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1302-1 in the processing platform 1300 comprises a processor 1310 coupled to a memory 1312.

The processor 1310 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1312 may comprise random access memory (RAM), read-only memory (ROM), flash memory or other types of memory, in any combination. The memory 1312 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based system log anomaly detection and remediation as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to generate a first data structure, the first data structure comprising a numerical representation of content of a given system log associated with at least one information technology asset;
to determine, utilizing the first data structure, a given one of a plurality of system log clusters to which the given system log belongs, each of the plurality of system log clusters comprising a set of non-anomalous system logs;
to select, from the given system log cluster, a subset of a given set of non-anomalous system logs which are part of the given system log cluster;
to perform contextual contrastive tuning of at least one machine learning model utilizing the selected subset of non-anomalous system logs;
to generate a second data structure utilizing the tuned at least one machine learning model, the tuned at least one machine learning model taking as input the first data structure, the second data structure characterizing (i) one or more anomalies detected in the given system log and (ii) one or more causes of at least one of the one or more anomalies detected in the given system log; and
to perform one or more remediation actions for the at least one information technology asset, the one or more remediation actions being selected based at least in part on the second data structure.

2. The apparatus of claim 1 wherein the first data structure comprises a vectorized representation of a sequence of message codes of the given system log.

3. The apparatus of claim 2 wherein the at least one processing device is further configured to apply pre-processing to the given system log to remove duplicate consecutive message codes in the sequence of message codes.

4. The apparatus of claim 2 wherein the at least one processing device is further configured is further configured to apply pre-processing to the given system log by removing one or more stop message codes from the sequence of message codes.

5. The apparatus of claim 4 wherein the one or more stop message codes are identified utilizing term frequency-inverse document frequency (TF-IDF) of message codes in a plurality of system logs.

6. The apparatus of claim 1 wherein determining the given system log cluster comprises computing a Euclidean distance between the numerical representation of the content of the given system log and cluster centroids of the plurality of system log clusters.

7. The apparatus of claim 1 wherein the plurality of system log clusters is generated based at least in part on applying a clustering algorithm to numerical representations of the sets of non-anomalous system logs.

8. The apparatus of claim 7 wherein the clustering algorithm comprises a Balanced Iterative Reducing and Clustering Using Hierarchies (BIRCH) clustering algorithm.

9. The apparatus of claim 1 wherein selecting the subset of the given set of non-anomalous system logs which are part of the given system log cluster comprises selecting a designated threshold number of the given set of non-anomalous system logs closest to a cluster centroid of the given system log cluster.

10. The apparatus of claim 1 wherein the at least one processing device is further configured to perform anomaly detection tuning of the at least one machine learning model utilizing anomaly reasons for anomalous sequences of message code sequences learned from historical anomalous system logs.

11. The apparatus of claim 1 wherein the at least one machine learning model comprises a large language model.

12. The apparatus of claim 1 wherein the at least one processing device is further configured to perform syntactical tuning of the at least one machine learning model for a given domain associated with the at least one information technology asset.

13. The apparatus of claim 12 wherein performing the syntactical tuning of the at least one machine learning model is based at least in part on analysis of unique message code combinations in a plurality of system logs produced by one or more information technology assets associated with the given domain.

14. The apparatus of claim 12 wherein the given domain comprises message code terminology used in message codes of system logs produced by the at least one information technology asset.

15. A computer program product comprising a non-transitory processor-readable storage medium having stored therein program code of one or more software programs, wherein the program code when executed by at least one processing device causes the at least one processing device:
to generate a first data structure, the first data structure comprising a numerical representation of content of a given system log associated with at least one information technology asset;
to determine, utilizing the first data structure, a given one of a plurality of system log clusters to which the given system log belongs, each of the plurality of system log clusters comprising a set of non-anomalous system logs;
to select, from the given system log cluster, a subset of a given set of non-anomalous system logs which are part of the given system log cluster;
to perform contextual contrastive tuning of at least one machine learning model utilizing the selected subset of non-anomalous system logs;
to generate a second data structure utilizing the tuned at least one machine learning model, the tuned at least one machine learning model taking as input the first data structure, the second data structure characterizing (i) one or more anomalies detected in the given system log and (ii) one or more causes of at least one of the one or more anomalies detected in the given system log; and
to perform one or more remediation actions for the at least one information technology asset, the one or more remediation actions being selected based at least in part on the second data structure.

16. The computer program product of claim 15 wherein the first data structure comprises a vectorized representation of a sequence of message codes of the given system log.

17. The computer program product of claim 15 wherein the program code when executed by the at least one processing device further causes the at least one processing device to perform syntactical tuning of the at least one machine learning model for a given domain associated with the at least one information technology asset.

18. A method comprising:
generating a first data structure, the first data structure comprising a numerical representation of content of a given system log associated with at least one information technology asset;
determining, utilizing the first data structure, a given one of a plurality of system log clusters to which the given system log belongs, each of the plurality of system log clusters comprising a set of non-anomalous system logs;
selecting, from the given system log cluster, a subset of a given set of non-anomalous system logs which are part of the given system log cluster;
performing contextual contrastive tuning of at least one machine learning model utilizing the selected subset of non-anomalous system logs;
generating a second data structure utilizing the tuned at least one machine learning model, the tuned at least one machine learning model taking as input the first data structure, the second data structure characterizing (i) one or more anomalies detected in the given system log and (ii) one or more causes of at least one of the one or more anomalies detected in the given system log; and
performing one or more remediation actions for the at least one information technology asset, the one or more remediation actions being selected based at least in part on the second data structure;
wherein the method is performed by at least one processing device comprising a processor coupled to a memory.

19. The method of claim 18 wherein the first data structure comprises a vectorized representation of a sequence of message codes of the given system log.

20. The method of claim 18 further comprising performing syntactical tuning of the at least one machine learning model for a given domain associated with the at least one information technology asset.
